(19) United States
(12) Patent Application Publication
(10) Pub. No.: US 2009/0183643 A1
(43) Pub. Date: Jul. 23, 2009

(54) Structure of roller imprinting apparatus

(76) Inventors: Sen-Yeu Yang, Taipei (TW); Sue-Wen Xu, Taipei (TW); Jing-Tang Wu, Taipei (TW); Bin-Da Chan, Taipei (TW); Tzu-Chien Huang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,981

(22) Filed: Jan. 14, 2009

(30) Foreign Application Priority Data
Jan. 18, 2008 (TW) 097101959

(51) Int. Cl. B41J 27/00

(52) U.S. Cl. 101/105

(57) ABSTRACT

A roller imprinting apparatus avoiding the drawbacks of deformation of the imprinting apparatus, incomplete imprint and side collapse upon mold stripping is disclosed to include a plurality of transmission rollers respectively spaced from one another at a distance, an imprinting belt extending around the transmission rollers and carrying one or a number of imprint structures and defining a imprinting zone and adapted for imprinting the imprint structures in a substrate, and a curer disposed corresponding to the imprinting zone and adapted for curing the substrate being imprinted with the imprinting belt.

### BACKGROUND OF THE INVENTION

The present invention relates to a roller imprinting apparatus and more particularly, to an improved structure of roller imprinting apparatus for planar imprint to imprint an imprint structure in the substrate.

Following fast development of photoelectric technology, the demand for consumer electronic products is increasing daily and, the market of photoelectric products shows a trend toward micro-size designs. Photoelectric products commonly utilize nanometered devices, such as micro mirror devices, micro-lens moldings or diffraction photochemical devices, and etc. The fabrication of conventional micro-lens arrays requires expensive manufacturing equipments. Further, conventional manufacturing processes for the fabrication of micro-lens arrays are commonly complicated and require much manufacturing time, and the related manufacturing cost is high. More particularly, conventional techniques are not suitable for mass production. Therefore, it is important to create a new technology suitable for mass production. Nano-imprint lithography was developed to imprint a nanostructure of a female die in a photoresist at a substrate and then to cure the imprinted photoresist through an ultraviolet radiation step, thereby forming a nanostructure on the substrate. However, the product size according to this imprint technology is limited to the size of the female die. Further, because this imprint technology requires much processing time, it does not facilitate rapid production. In consequence, roller imprint technology is developed. FIG. 1 illustrates a conventional roller imprinting apparatus 10. According to this design, the roller imprinting apparatus 10 comprises an imprinting roller 11 that has at least one imprint structure 12 or, is covered with a flexible imprinting film 13 carrying at least one imprint structure 12. When rotating the imprinting roller 11 over a substrate 14, the desired imprint structure 12 is formed on the substrate 14.

### SUMMARY OF THE PRESENT INVENTION

It is, therefore, the primary object of the present invention to provide an improved structure of roller imprinting apparatus that defines an imprinting zone by means of utilizing a number of transmission rollers and an imprinting belt that carries at least one imprint structure and is mounted around the transmission rollers, increasing the contact distance and time between the imprinting apparatus and the substrate to be imprinted, avoiding the drawbacks of deformation of the imprinting apparatus, incomplete imprint and side collapse upon mold stripping.

It is another object of the present invention to provide an improved structure of roller imprinting apparatus that utilizes at least one auxiliary roller to keep the part of the imprinting belt that contacts the substrate within the imprinting zone in level, enabling the imprinting pressure of the imprinting belt to be evenly applied to the substrate so that the substrate can have the imprint structure be imprinted therein completely.

It is still another object of the present invention to provide an improved structure of roller imprinting apparatus that defines multiple imprinting zones for imprinting multiple substrates at a time by means of utilizing multiple sets of transmission rollers and an imprinting belt that carries at least one imprint structure and is mounted around the multiple sets of transmission rollers.

To achieve these and other objects of the present invention, the roller imprinting apparatus comprises a plurality of transmission rollers respectively spaced from one another at a distance, an imprinting belt that has an inner side extending around the transmission rollers and an outer side provided with at least one imprint structure and defines a imprinting zone, and at least one curer respectively disposed corresponding to the at least one imprinting zone.

### BRIEF DESCRIPTION OF THE DRAWINGS

FIG. 1 is a sectional view of a roller imprinting apparatus according to the prior art.

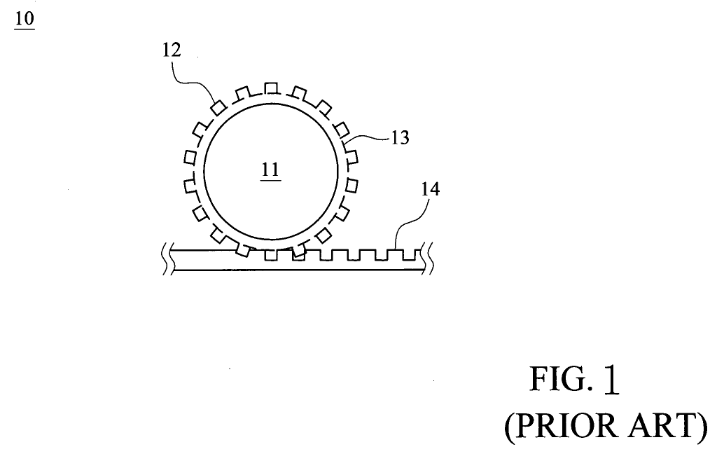

FIG. 2A is a sectional view of a roller imprinting apparatus in accordance with a first embodiment of the present invention.

FIG. 2B is a sectional view of a substrate processed through a roller imprinting apparatus in accordance with the first embodiment of the present invention.

FIG. 3 is a sectional view of a roller imprinting apparatus in accordance with a second embodiment of the present invention.

FIG. 4A is a sectional view of a roller imprinting apparatus in accordance with a third embodiment of the present invention.

FIG. 4B is a sectional view of a substrate processed through a roller imprinting apparatus in accordance with the third embodiment of the present invention.

FIG. 5 is a sectional view of a roller imprinting apparatus in accordance with a fourth embodiment of the present invention.

FIG. 6 is a sectional view of a roller imprinting apparatus in accordance with a fifth embodiment of the present invention.

FIG. 7 is a sectional view of a roller imprinting apparatus in accordance with a sixth embodiment of the present invention.

### DETAILED DESCRIPTION OF THE PREFERRED EMBODIMENTS

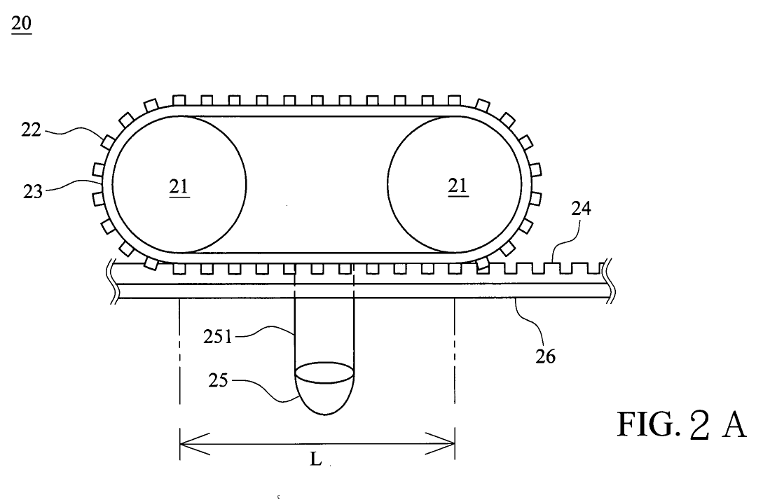

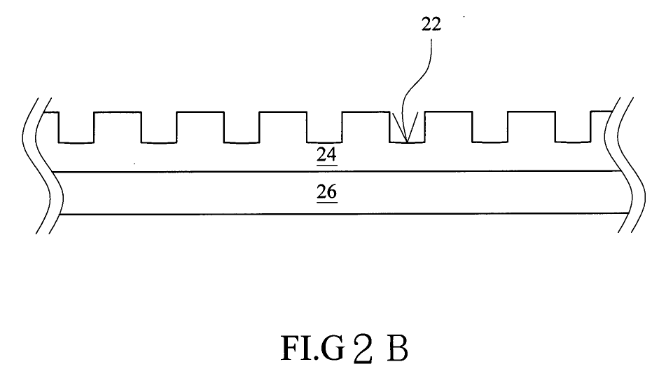

Please refer to FIGS. 2A and 2B, a roller imprinting apparatus 20 in accordance with a first embodiment of the present invention is shown comprised of a plurality of, for example, two transmission rollers 21 and an imprinting belt 23. The transmission rollers 21 are arranged in a parallel manner and spaced from each other at a predetermined distance. The imprinting belt 23 is an endless belt mounted on and rotatable by the transmission rollers 21, carrying at least one imprint structure 22 at the outer surface. The imprinting belt 23 defines an imprinting zone L. The roller imprinting apparatus 20 further comprises a curer 25 located on a location corresponding to the imprinting zone -L. According to this embodiment, the curer 25 is disposed right below the imprinting zone L. A substrate 24 (for example, thermoplastic substrate) is placed on a worktable 26 and kept in contact with one side of the imprinting belt 23. The substrate 24 and the worktable 26 are arranged in between the imprinting zone L and the curer 25. During rotation of the transmission rollers 21 to move the imprinting belt 23, a friction force is produced between the imprinting belt 23 and the substrate 24 to move the substrate 24 through the imprinting zone L and to have the imprint structure 22 be imprinted on the substrate 24. At the same time, the curer 25 cures the substrate 24, completing the imprinting procedure, as shown in FIG. 2B. The imprinting zone L is a plane. Therefore, the contact distance and contact time between the imprint structure 22 and the imprinted on the substrate 24 are relatively increased. When compared with the conventional single-roller type roller imprinting apparatus, the invention eliminates the drawbacks of deformation of imprint structure, incomplete imprint and side collapse upon mold stripping. After the imprint process, the substrate 24 obtains a complete imprint structure 22.

The type of the curer 25 is determined subject to the structure of the substrate 24 used. The curer 25 generates a curing source 251 that contacts a part of the surface of the substrate 24 to cure the substrate 24. According to this embodiment, the curer 25 is a UV generator that generates an ultraviolet light source to radiate a part of the surface of the substrate 24, for example, the middle and/or rear area of the imprinting zone L. According to this embodiment, the substrate 24 is prepared from a photo curable material. For allowing radiation of the ultraviolet light source onto the substrate 24, the worktable 26 can be made having a through hole (not shown), and the substrate 24 can be made of a light-transmissive material. Alternatively, both the worktable 26 and the substrate 24 can be made of a light-transmissive material. Under either of the aforesaid two alternative arrangements, the substrate 24 will contact the imprinting belt 23 in the front area of the imprinting zone L for enabling the imprint structure 22 to be imprinted in the substrate 24. At this time, the substrate 24 is still plasticable. When the imprinting belt 23 is carrying the substrate 24 to the middle and/or rear area of the imprinting zone L, the curing source 251 generated by the curer 25 cures the substrate 24. After disengagement of the substrate 24 from the imprinting belt 23, the imprint structure 22 is formed on the substrate 24. The curer 25 can be a heat source generator adapted for generating a heat source. In this case, the substrate 24 can be prepared from a thermosetting material. By means of radiation or heat transfer, the heat source generated by the curer 25 contacts a predetermined part of the surface of the substrate 24, thereby curing the substrate 24.

According to this embodiment, the imprinting belt 23 is an endless thin film, and the imprint structure 22 is a nano structure. Therefore, this embodiment is for nano structure imprint. However, the imprint structure 22 is not limited to nano structure. Any other imprint structures greater or smaller than the size of nanoscale are applicable to achieve the effects of the present invention.

Further, the imprinting belt 23 can be prepared from a flexible material (such as flexible polymeric material, polyethylene terephthalate, polycarbonate, or polyurethane-acrylate), rubber, nickel or resilient stainless steel, and extended around the transmission rollers 21 for flexible rotation subject to rotation of the transmission rollers 21.

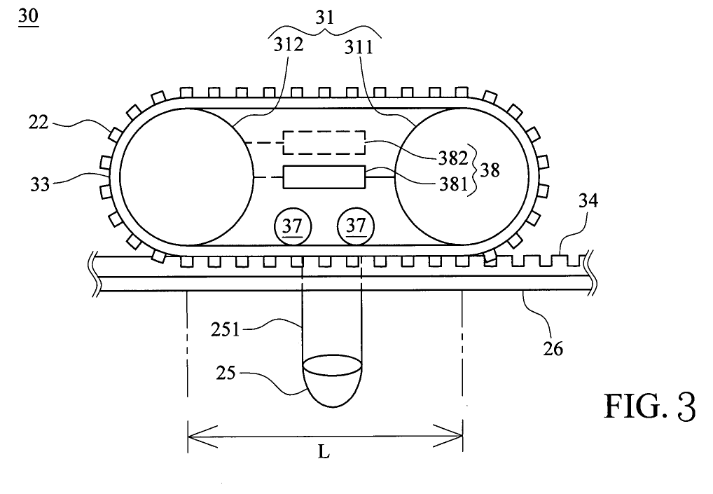

FIG. 3 illustrates a roller imprinting apparatus 30 in accordance with a second embodiment of the present invention. This second embodiment is substantially similar to the aforesaid first embodiment with the exception that this second embodiment further comprises at least one, for example, two auxiliary rollers 37 and at least one, for example, two actuators 38. The auxiliary rollers 37 are mounted within the imprinting zone L and closely attached to the inner surface of the imprinting belt, referenced by 33 to keep the part of the imprinting belt 33 that contacts the substrate, referenced by 34 within the imprinting zone L in level, enabling the imprinting pressure of the imprinting belt 33 to be evenly applied to the substrate 34 so that the substrate 34 can have the imprint structure 22 be imprinted therein completely. According to this embodiment, two actuators 38, i.e., the first actuator 381 and the second actuator 382 are respectively coupled to the first transmission roller 311 and second transmission roller 312 of the transmission rollers 31 of the roller imprinting apparatus 30 and simultaneously controlled to rotate the first transmission roller 311 and second transmission roller 312 of the transmission rollers 31 at a same speed. Alternatively, one single actuator can be used to rotate the first transmission roller 311 and second transmission roller 312 of the transmission rollers 31 at a predetermined speed.

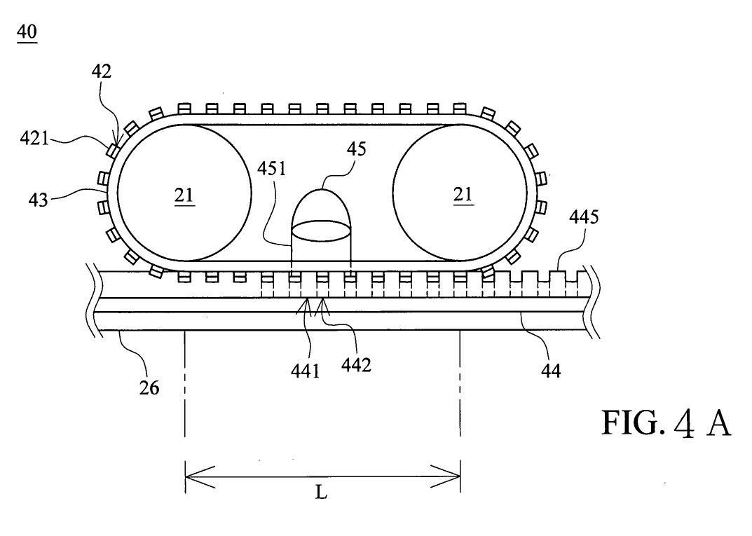

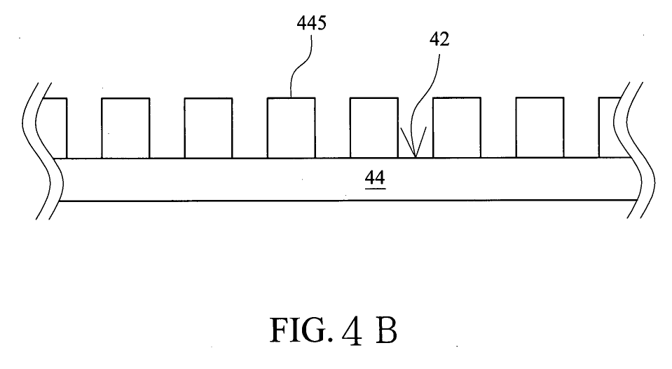

FIGS. 4A and 4B show a roller imprinting apparatus 40 in accordance with a third embodiment of the present invention. According to this embodiment, the substrate 44 has an imprintable layer 445 (for example, photo curable material) on the top side thereof. To avoid residual imprintable layer on the substrate 44 after imprint, each imprint structure 42 of the imprinting belt 43 has a black matrix layer 421 formed thereon through a coating technique to provide a hybrid mask mold. The imprinting belt 43 is prepared from a light-transmissive material. An UV generator 45 is disposed in a space surrounded by the transmission belt 43, and controlled to generate an ultraviolet light source 451 that radiates through the imprinting belt 43 onto a predetermined part of the surface of the substrate 44. The substrate 44 contacts the imprinting belt 43 in the front area of the imprinting zone L, for enabling the imprint structure 42 to be imprinted in the substrate 44. When the imprinting belt 43 is carrying the substrate 44 to the middle and/or rear area of the imprinting zone L, the ultraviolet light source 451 generated by the UV generator 45 cures multiple light-receiving portions 441 of the substrate 44. After disengagement of the substrate 44 from the imprinting belt 43, a solvent (not shown) is applied to remove at least one non-radiated portion 442. Thus, the substrate 44 is processed to have the desired imprint structure 42 formed thereon without any residual imprintable layer left thereon, as shown in FIG. 4B.

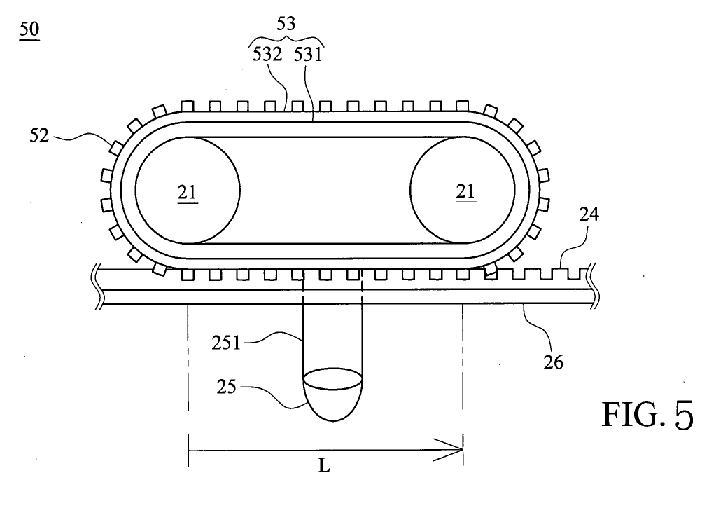

FIG. 5 is a sectional view of a roller imprinting apparatus in accordance with a fourth embodiment of the present invention. According to this embodiment, the imprinting belt 53 is comprised of a thin-film loop 531 and an imprint mold 532. The imprint mold 532 has an outer surface provided with at least one imprint structure 52 and an inner surface surrounding the thin-film loop 531.

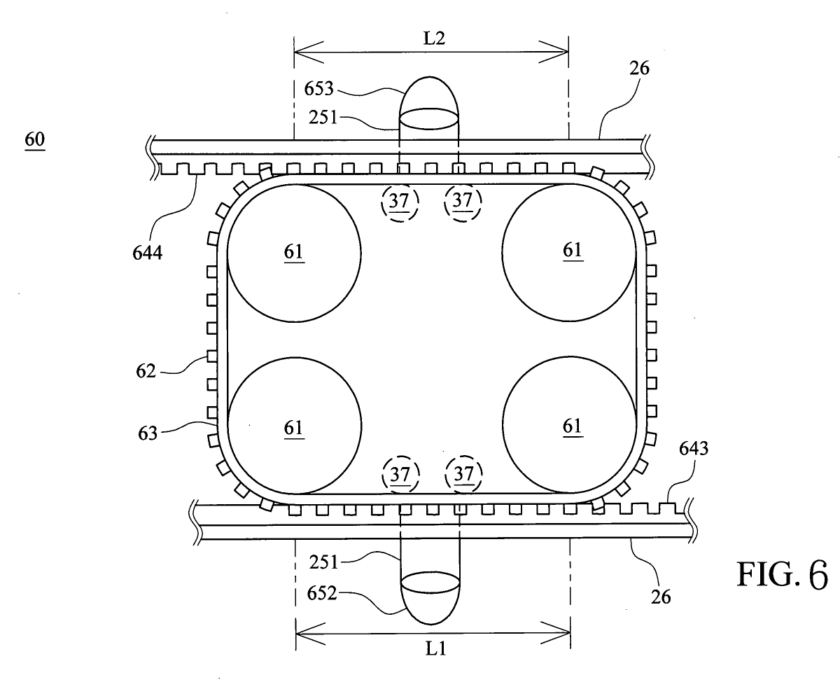

FIG. 6 is a sectional view of a roller imprinting apparatus 60 in accordance with a fifth embodiment of the present invention. According to this fifth embodiment, the imprinting belt 63 is mounted on multiple transmission rollers 61, defining multiple imprinting zones for imprinting multiple workpieces at a time. For example, the imprinting belt 63 is mounted on four transmission rollers 61 in four corners, defining a first imprinting zone L1 at one side and a second imprinting zone L2 at an opposing side; a first curer 652 and a second curer 653 are respectively arranged outside by corresponding to the first imprinting zone L1 and the second imprinting zone L2. A first substrate 643 and a second substrate 644 are provided at two opposite sides of the roller imprinting apparatus 60. When driving the transmission rollers 61 to rotate the imprinting belt 63, a friction force is produced between the imprinting belt 63 and each of the first substrate 643 and the second substrate 644 to carry the first substrate 643 through the first imprinting zone L1 and the second substrate 644 through the second imprinting zone L2, enabling the imprint structure 62 to be imprinted in the first substrate 643 and the second substrate 644 and then cured by the curers 652 and 53.

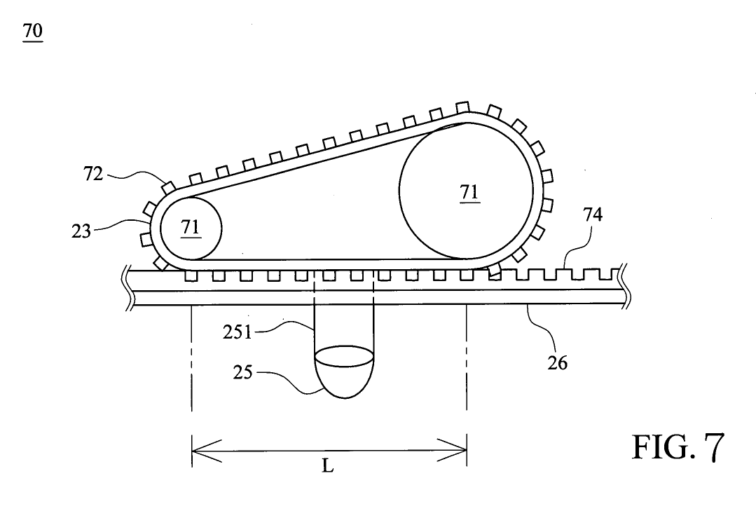

FIG. 7 is a sectional view of a roller imprinting apparatus 70 in accordance with a sixth embodiment of the present invention. This embodiment is substantially similar to the aforesaid first embodiment with the exception that the transmission rollers 71 of the roller imprinting apparatus 70 according to this sixth embodiment have different diameters. The roller imprinting apparatus 70 defines an imprinting zone L for planar imprint to imprint an imprint structure 72 in the substrate 74.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A roller imprinting apparatus, comprising:
a plurality of transmission rollers respectively spaced from one another at a distance;
an imprinting belt rotatable by said transmission rollers, said imprinting belt having an inner side extending around said transmission rollers and an outer side provided with at least one imprint structure and defining a imprinting zone; and
curer means disposed corresponding to said imprinting zone.

2. The roller imprinting apparatus as claimed in claim 1 wherein said imprinting belt is an endless belt formed of a thin-film material.

3. The roller imprinting apparatus as claimed in claim 1 wherein said imprinting belt is comprised of a thin-film loop and an imprint mold, said imprint mold having an outer side provided with at least one imprint structure and an inner side covered on said thin-film loop.

4. The roller imprinting apparatus as claimed in claim 1 wherein each said imprint structure has an outer surface thereof coated with a black matrix array; said imprinting belt is prepared from a light-transmissive material; said curer means is comprised of a light curer.

5. The roller imprinting apparatus as claimed in claim 1 wherein said imprinting belt is prepared from a flexible material.

6. The roller imprinting apparatus as claimed in claim 1, further comprising at least one actuator means coupled to said transmission rollers and adapted for rotating said transmission rollers.

7. The roller imprinting apparatus as claimed in claim 1, further comprising at least one auxiliary roller mounted in between said transmission rollers and closely attached to the inner side of said imprinting belt.

8. The roller imprinting apparatus as claimed in claim 1 wherein each said imprint structure is a nano structure.

9. The roller imprinting apparatus as claimed in claim 1 wherein said curer means comprises at least one of light curers and temperature-control curers.

10. The roller imprinting apparatus as claimed in claim 1 wherein said imprinting zone is a plane.
